(19) United States
(12) Patent Application Publication
(10) Pub. No.: US 2009/0326123 A1
(43) Pub. Date: Dec. 31, 2009

(54) POLYPROPYLENE RESIN COMPOSITION AND MOLDED ARTICLE MADE THEREOF

(75) Inventors: Hiroyoshi Nakajima, Chiba (JP); Takashi Fujimoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku (JP)

(21) Appl. No.: 12/520,446

(22) PCT Filed: Dec. 26, 2006
(86) PCT No.: PCT/JP2007/075386

§ 371 Date: Jun. 19, 2009

(30) Foreign Application Priority Data
Dec. 26, 2006 (JP) 2006-349245
Apr. 3, 2007 (JP) 2007-097515
Apr. 3, 2007 (JP) 2007-097516

(51) Int. Cl. C08L 23/12; C08K 5/14

(52) U.S. Cl. 524/394; 525/240; 524/528

(57) ABSTRACT

A polypropylene resin composition is provided which contains 50 to 90% by weight of a propylene polymer (A) selected from the group consisting of a propylene homopolymer (A-1) and a propylene-ethylene copolymer (A-2), 5 to 20% by weight of a propylene-ethylene-α-olefin copolymer (B) given below and 5 to 30% by weight of an ethylene-α-olefin copolymer (C) given below, wherein the composition has a melt index, measured at 230° C. under a load of 2.16 kg, of greater than 40 g/10 minutes but not greater than 200 g/10 minutes,

propylene-ethylene-α-olefin copolymer (B): a copolymer composed of 5 to 99 mol % of propylene units, 60 mol % or less of ethylene units and 1 to 35 mol % of α-olefin units, wherein the α-olefin has 4 to 20 carbon atoms, the copolymer has a molecular weight distribution of 1 to 4, an intrinsic viscosity of 0.5 to 10 dl/g and a heat of fusion of 30 J/g or less,

ethylene-α-olefin copolymer (C): a copolymer of ethylene and α-olefin having a density of 0.85 to 0.89 g/cm³, wherein the α-olefin has 4 to 20 carbon atoms.

### TECHNICAL FIELD

The present invention relates to polypropylene resin compositions and molded articles made thereof. Particularly, the present invention relates to polypropylene resin compositions from which foam-molded articles having few silver streaks can be obtained and to molded articles made thereof.

Furthermore, the present invention relates to a polypropylene resin composition from which a foam molded article having few silver streaks and less corrugation can be obtained because of its good fluidity and to a molded article made of the same.

Furthermore, the present invention relates to a polypropylene resin composition from which a foam molded article having few silver streaks and uniform foamed cells and to a molded article made of the same.

### BACKGROUND ART

Polypropylene resins have heretofore been used as materials for automobiles because of their high rigidity and high impact resistance.

For example, JP 11-293058 A discloses, as a technology for improving rigidity and impact, resistance, a thermoplastic resin composition which comprises a polypropylene resin, an olefin-based copolymer obtained by copolymerizing two or more olefins having six or more carbon atoms in total selected from ethylene, propylene and α-olefins, and an inorganic filler.

JP 2001-192509 A discloses, as a technology for improving flexibility and heat resistance, a thermoplastic resin composition having a Shore A hardness of 85 or less which comprises a non-crystalline olefin-based polymer having a strength at tensile breakage of less than 2 MPa and a crystalline olefin-based resin.

### DISCLOSURE OF THE INVENTION

One object of the present invention is to provide a polypropylene resin composition from which a molded article with few silver streaks can be obtained and a molded article made of the same.

Silver streaks are whitened short appearance defects resulting from foaming. In a molding process, continuous long appearance defects extending radiately from gates, called “corrugation”, may be formed. The corrugation is appearance defects, which have not been whitened and are distinguished from silver streaks.

Another object of the present invention is to provide a polypropylene resin composition with good fluidity from which a molded article having few silver streaks and less corrugation can be obtained and a molded article made of the same.

Still another object of the present invention is to provide a polypropylene resin composition from which a molded article having few silver streaks and having uniform foamed cells can be obtained and a molded article made of the same.

The present invention, in one aspect, provides a polypropylene resin composition comprising:

50 to 90% by weight of a propylene polymer (A) selected from the group consisting of a propylene homopolymer (A-1) and a propylene-ethylene copolymer (A-2),

5 to 20% by weight of the following propylene-ethylene-α-olefin copolymer (B), and

5 to 30% by weight of the following ethylene-α-olefin copolymer (C), and

having a melt index, measured at 230° C. under a load of 2.16 kg, of greater than 40 g/10 minutes but not greater than 200 g/10 minutes, wherein the amounts of the propylene polymer (A), the propylene-ethylene-α-olefin copolymer (B) and the ethylene-α-olefin copolymer (C) are each relative to the total amount of these components,

propylene-ethylene-α-olefin copolymer (B): a copolymer composed of 5 to 99 mol % of propylene units, 60 mol % or less of ethylene units and 1 to 35 mol % of α-olefin units, wherein the α-olefin has 4 to 20 carbon atoms, the copolymer has a molecular weight distribution of 1 to 4, an intrinsic viscosity of 0.5 to 10 dl/g and a heat of fusion of 30 J/g or less, wherein the content of the propylene units, the content of the ethylene units and the content of the α-olefin units, each in mol %, are based on the total amount of these monomer units,

ethylene-α-olefin copolymer (C): a copolymer of ethylene and α-olefin having a density of 0.85 to 0.89 g/cm³, wherein the α-olefin has 4 to 20 carbon atoms.

This may be called a “first resin composition.”

It is possible to convert the first resin composition into a resin composition higher in fluidity by heating it in the presence of an organic peroxide.

The present invention, in another aspect, provides a polypropylene resin composition for foam-molding comprising:

50 to 90% by weight of a propylene polymer (A) selected from the group consisting of a propylene homopolymer (A-1) and a propylene-ethylene copolymer (A-2),

5 to 20% by weight of the following olefin-based polymer (B′), and

5 to 30% by weight of the following ethylene-α-olefin copolymer (C), and

having a melt index, measured at 230° C. under a load of 2.16 kg, of greater than 40 g/10 minutes but not greater than 200 g/10 minutes, wherein the foregoing amounts of the propylene polymer (A), the olefin-based polymer (B′) and the ethylene-α-olefin copolymer (C) are each relative to the total amount of these components,

olefin-based polymer (B′): a polymer obtained by heating 100 parts by weight of a propylene-ethylene-α-olefin copolymer (b1) provided below or 100 parts of a mixture composed of not less than 25% by weight but less than 100% by weight of a propylene-ethylene-α-olefin copolymer (b1) and not more than 75% by weight of a propylene polymer (b4) selected from the group consisting of a propylene homopolymer (b2) and a propylene-ethylene copolymer (b3), in the presence of 0.001 to 20 parts by weight of an organic peroxide (b5), wherein the olefin-based polymer (B′) has a melt index, measured at 230° C. under a load of 2.16 kg, of 10 to 100 g/10 minutes,

propylene-ethylene-α-olefin copolymer (b1): a copolymer composed of 5 to 99 mol % of propylene units, 60 mol % or less of ethylene units and 1 to 35 mol % of α-olefin units, wherein the α-olefin has 4 to 20 carbon atoms, the copolymer has a molecular weight distribution of 1 to 4, an intrinsic viscosity of 0.5 to 10 dl/g and a heat of fusion of 30 J/g or less, wherein the content of the propylene units, the content of the ethylene units and the content of the α-olefin units, each in mol %, are based on the total amount of these monomer units,

ethylene-α-olefin copolymer (C): a copolymer of ethylene and α-olefin having a density of 0.85 to 0.89 g/cm³, wherein the α-olefin has 4 to 20 carbon atoms.

This may be called a “second resin composition.”

In another aspect, the present invention provides an injection molded article made of any of the foregoing polypropylene resin compositions.

In another aspect, the present invention provides a foam molded article made of any of the foregoing polypropylene resin compositions.

### BRIEF DESCRIPTION OF THE DRAWINGS

FIG. 1 is a perspective view of the foam molded article of the polypropylene resin composition produced in Example 1. In the drawing, referential sign 1 denotes a gate contact portion, and 2 represents a portion where silver streaks, corrugation and the foamed cell condition were evaluated.

### MODE FOR CARRYING OUT THE INVENTION

### First Resin Composition

In the present invention, at least one propylene polymer (A) selected from the group consisting of a propylene homopolymer (A-1) and a propylene-ethylene copolymer (A-2) is used. The propylene-ethylene copolymer (A-2) may be a propylene-ethylene random copolymer (A-2-1) or a propylene-ethylene block copolymer (A-2-2). The propylene-ethylene block copolymer (A-2-2) is a copolymer composed of a propylene homopolymer component and a propylene-ethylene random copolymer component.

From the viewpoint of rigidity, heat resistance or hardness, the propylene polymer (A) preferably is a propylene homopolymer (A-1) or a propylene-ethylene block copolymer (A-2-2).

The propylene homopolymer (A-1) preferably has an isotactic pentad fraction, measured by ¹³C-NMR, of not less than 0.95, and more preferably not less than 0.98.

The propylene homopolymer component of the propylene-ethylene block copolymer (A-2-2) preferably has an isotactic pentad fraction, measured by ¹³C-NMR, of not less than 0.95, and more preferably not less than 0.98.

The isotactic pentad fraction is a fraction of propylene monomer units which are present at the center of an isotactic chain in the form of a pentad unit in the polypropylene molecular chain, in other words, a fraction of propylene monomer units present at the center of a chain in which five propylene monomer units are meso-bonded successively in the polypropylene molecular chain. The method for measuring the isotactic pentad fraction is the method disclosed by A. Zambelli et al. in Macromolecules 6, 925 (1973), namely, a method in which the measurement is performed by using ¹³C-NMR. However, NMR absorption peaks are assigned according to Macromolecules, 8, 687 (1975).

Specifically, the isotactic pentad fraction is a ratio of the mmmm peak area to the total peak area in the methyl carbon ranges observed in a ¹³C-NMR spectrum. According to this method, the isotactic pentad fraction of an NPL standard substance, CRM No. M19-14 Polypropylene PP/MWD/2 available from NATIONAL PHYSICAL LABORATORY, G. B. was measured to be 0.944.

The intrinsic viscosity of the propylene homopolymer (A-1) measured in Tetralin solvent of 135° C. ([η]_{P}), the intrinsic viscosity of the propylene homopolymer component of the block copolymer (A-2-2) measured in Tetralin solvent of 135° C. ([η]_{P}) and the intrinsic viscosity of the random copolymer (A-2-1) measured in Tetralin solvent of 135° C. ([η]) each are usually 0.7 to 5 dl/g, and preferably are 0.8 to 4 dl/g.

The molecular weight distributions (i.e., Q value or Mw/Mn) measured by gel permeation chromatography (GPC) of the propylene homopolymer (A-1), the propylene homopolymer component of the block copolymer (A-2-2) and the random copolymer (A-2-1) are each preferably from 3 to 7.

The content of ethylene contained in the propylene-ethylene random copolymer component of the block copolymer (A-2-2) is 20 to 65% by weight, and preferably is 25 to 50% by weight, wherein the overall amount of the propylene-ethylene random copolymer component is let be 100% by weight.

The intrinsic viscosity of the propylene-ethylene random copolymer component of the block copolymer (A-2-2) measured in Tetralin solvent of 135° C. ([η]_{EP}) usually is 1.5 to 12 dl/g, and preferably is 2 to 8 dl/g.

The content of the propylene-ethylene random copolymer component which constitutes the block copolymer (A-2-2) preferably is 10 to 60% by weight, and more preferably is 10 to 40% by weight.

The melt index (MI) of the propylene homopolymer (A-1) usually is 0.1 to 400 g/10 min, and preferably is 1 to 300 g/10 min, wherein the measurement was performed at a temperature of 230° C. and a load of 2.16 kg.

The melt index (MI) of the propylene-ethylene copolymer (A-2) usually is 0.1 to 200 g/10 minutes, and preferably is 5 to 150 g/10 minutes, wherein the measurement was performed at a temperature of 230° C. and a load of 2.16 kg.

The method for producing the propylene polymer (A) may, for example, be a method in which it is produced by using a conventional polymerization catalyst and a conventional polymerization method.

The conventional polymerization catalyst to be used in the method for producing the propylene polymer (A) may be a catalyst system composed of (1) a solid catalyst component containing magnesium, titanium, halogen and an electron donor as essential components, (2) an organoaluminum compound and (3) an electron donating component. Examples of the method for preparing this type of catalyst include the methods disclosed in JP 1-319508 A, JP 7-216017 A and JP 10-212319 A.

Examples of the polymerization method to be used in the production method include bulk polymerization, solution polymerization, slurry polymerization and vapor phase polymerization. Such polymerization methods may be conducted either in a batch system or in a continuous system. Such polymerization methods may also be combined optionally.

The method for producing the propylene-ethylene block copolymer (A-2-2) preferably is a method in which two or more polymerization vessels are arranged in series in the presence of the aforementioned catalyst system composed of (1) a solid catalyst component, (2) an organoaluminium compound and (3) an electron donating component, the propylene homopolymer component of a propylene-ethylene block copolymer is produced and then is transferred to a next polymerization vessel, and subsequently the propylene-ethylene random copolymer component is produced continuously in the polymerization vessel, so that the propylene-ethylene block copolymer is produced.

The amounts of (1) the solid catalyst component, (2) the organoaluminum compound and (3) the electron donating component used in the polymerization method and the method for feeding the catalyst components into polymerization vessels may be determined appropriately.

The polymerization temperature usually is −30 to 300° C., and preferably is 20 to 180° C. The polymerization pressure usually is normal pressure to 10 MPa, and preferably is 0.2 to 5 MPa. As a molecular weight regulator, hydrogen, for example, may be used.

In the production of the propylene polymer (A), pre-polymerization may be conducted prior to the main polymerization. One example of known methods of the pre-polymerization is a method in which pre-polymerization is carried out in a slurry state using a solvent while feeding a small amount of propylene in the presence of (1) a solid catalyst component and (2) an organoaluminum compound.

The propylene-ethylene-α-olefin copolymer (B) is a copolymer which is composed of 5 to 99 mol % of propylene units, 60 mol % or less of ethylene units and 1 to 35 mol % of α-olefin units.

Examples of the α-olefin in the propylene-ethylene-α-olefin copolymer (B) include α-olefins having 4 to 20 carbon atoms.

Examples of the α-olefins having 4 to 20 carbon atoms include straight chain α-olefins and branched α-olefins. Examples of the straight chain α-olefins include 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nanodecene, and 1-eicosene. Examples of the branched α-olefins include 3-methyl-1-butene, 3-methyl-1-pentene, 4-methyl-1-pentene and 2-ethyl-1-hexene. The content of the propylene units contained in the copolymer (B) is 5 to 99 mol %, preferably is 25 to 99 mol %, and more preferably is 35 to 99 mol %. The content of the ethylene units is 0 to 60 mol %, and preferably is 0 to 55 mol %. The content of the α-olefin units is 1 to 35 mol %, preferably is 1 to 20 mol %, and more preferably is 1 to 10 mol %. It is noted that the propylene unit content, the ethylene unit content and the α-olefin unit content are each based on the total amount of these monomer units.

The copolymer (B) preferably satisfies the relation ship represented by the following formula:

0.1<[y/(x+y)]≦1.0,

more preferably 0.5<[y/(x+y)]≦1.0, and even more preferably 0.8<[y/(x+y)]≦1.0. In the above formulas, x represents the content of the ethylene units in (B), and y represents the sum total of the contents of the α-olefin units having 4 to 20 carbon atoms in (B).

The intrinsic viscosity [η] of the copolymer (B) measured in Tetralin of 135° C. is 0.5 to 10 dl/g, preferably is 0.9 to 5 dl/g, and more preferably is 1.2 to 3 dl/g.

The copolymer (B) has a molecular weight distribution of 1 to 4. The molecular weight distribution is a ratio (Mw/Mn) of a weight average molecular weight (Mw) to a number average molecular weight (Mn) and is measured by gel permeation chromatograph (GPC) using standard polystyrenes as standard substances of molecular weight.

The amount of the heat of fusion of the copolymer (B) is 30 J/g or less, preferably is 20 J/g or less, and more preferably is 10 J/g or less. It more preferably is 0 J/g.

The first resin composition may contain two or more propylene-ethylene-α-olefin copolymers (B), which satisfy the above-mentioned requirements.

The method for producing the copolymer (B) may be a method in which given monomers are polymerized using a metallocene catalyst by slurry polymerization, solution polymerization, bulk polymerization, vapor phase polymerization, or the like.

Examples of such a metallocene catalyst include metallocene catalysts disclosed in JP 3-163088 A, JP 4-268307 A, JP 9-12790 A, JP 9-87313 A, JP 11-80233 A and JP 10-508055 A.

A preferable example of the method for producing the copolymer (B) using a metallocene catalyst is the method disclosed in EP 1211287 A.

Examples of the ethylene-α-olefin copolymer (C) to be used in the present invention include ethylene-α-olefin random copolymers and mixtures thereof.

The density of the copolymer (C) is 0.85 to 0.89 g/cm³, preferably is 0.85 to 0.88 g/cm³, and more preferably is 0.86 to 0.88 g/cm³.

The content of the ethylene contained in the copolymer (C) preferably is 20 to 95% by weight, and more preferably is 30 to 90% by weight. The content of the α-olefin preferably is 80 to 5% by weight, and more preferably is 70 to 10% by weight.

The MI (measured at a temperature of 190° C. under a load of 2.16 kg) of the copolymer (C) preferably is 0.5 to 100 g/10 minutes, more preferably is 1 to 50 g/10 minutes, and even more preferably is 10 to 40 g/10 minutes.

Examples of the α-olefin to be used for the copolymer (C) include α-olefins having 4 to 20 carbon atoms, and specific examples thereof include 1-butene, 1-pentene, 1-hexene, 4-methyl-1-pentene, 1-heptene, 1-octene, 1-decene, 1-dodecene, 1-tetradecene, 1-hexadecene, and 1-eicocene. Such α-olefins may be used singly or, alternatively, two or more α-olefins may be used in combination. Preferable α-olefins include α-olefins having from 4 to 12 carbon atoms, such as 1-butene, 1-hexene and 1-octene.

The method for producing the copolymer (C) may be a method basically the same as that to be used for the production of the copolymer (B). Examples of the catalyst to be used for the production of the copolymer (C) include metallocene catalysts the same as the catalysts which can be used for the production of the copolymer (B).

The first resin composition of the present invention may further contain an inorganic filler (D) in addition to the propylene polymer (A), the copolymer (B) and the ethylene-α-olefin copolymer (C).

Examples of the inorganic filler (D) include glass fiber, carbon fiber, metal fiber, glass beads, mica, calcium carbonate, potassium titanate whisker, talc, bentonite, smectite, mica, sepiolite, wollastonite, allophane, imogolite, fibrous magnesium oxysulfate, barium sulfate and glass flakes, and talc is preferred.

The average particle diameter of the inorganic filler (D) is usually from 0.01 to 50 μm, preferably from 0.1 to 30 μm, and more preferably from 0.1 to 5 μm. The average particle diameter of the inorganic filler (D) means a 50% equivalent particle diameter D50 which is determined from an integral distribution curve of the sub-sieve method which is produced by measuring a suspension of the inorganic filler (D) in a dispersing medium, such as water and alcohol, by means of a centrifugal sedimentation type particle size distribution analyzer.

In the preparation of the resin composition, the inorganic filler (D) may be used before being processed or alternatively, for the purpose of improving the interfacial adhesion strength to a polypropylene resin composition or improving the dispersibility of the inorganic filler in a polypropylene resin composition, may be used after treating the surface of the inorganic filler with conventional silane coupling agents, titanium coupling agents, higher fatty acids, higher fatty acid esters, higher fatty acid amides, higher fatty acid salts or other surfactants.

The content of the propylene polymer (A) is 50 to 90% by weight, preferably is 55 to 85% by weight, and more preferably is 60 to 80% by weight. The content of the propylene-ethylene-α-olefin copolymer (B) is 5 to 20% by weight, preferably is 5 to 15% by weight, and more preferably is 7 to 15% by weight. The content of the ethylene-α-olefin random copolymer (C) is 5 to 30% by weight, preferably is 10 to 30% by weight, and more preferably is 13 to 25% by weight, wherein the foregoing amounts of the propylene polymer (A), the propylene-ethylene-α-olefin copolymer (B) and the ethylene-α-olefin copolymer (C) are each relative to the total amount of these components.

The content of the inorganic filler (D) is 0.1 to 60 parts by weight, and from the viewpoint of impact resistance, it preferably is 1 to 30 parts by weight, and more preferably is 5 to 20 parts by weight relative to 100 parts by weight of the propylene polymer (A), the propylene-ethylene-α-olefin copolymer (B) and the ethylene-α-olefin copolymer (C) in total.

The MI (measured at a temperature of 230° C. under a load of 2.16 kg) of the polypropylene resin composition of the present invention is greater than 40 g/10 minutes but not greater than 200 g/10 minutes, preferably is greater than 40 g/10 minutes but not greater than 150 g/10 minutes, and more preferably is greater than 40 g/10 minutes but not greater than 120 g/10 minutes.

The method for producing the polypropylene resin composition of the present invention may be a method in which the components are kneaded. Examples of the apparatus to be used for the kneading include a single screw extruder, a twin screw extruder, a Banbury mixer, and a hot roll. The kneading temperature is usually 170 to 250° C., and the kneading time is usually from 1 to 20 minutes. Kneading of the components may be performed either simultaneously or separately.

The polypropylene resin composition of the present invention is allowed, if necessary, to contain additives, examples of which include neutralizing agents, antioxidants, light-resisting agents, UV absorbers, copper inhibitors, lubricants, processing aids, plasticizers, dispersing agents, antiblocking agents, antistatic agents, nucleating agents, flame retardants, foaming agents, foam inhibitors, crosslinking agents, and colorants such as pigments.

### Heat Treatment

The polypropylene resin composition containing the propylene polymer (A), the propylene-ethylene-α-olefin copolymer (B) and the ethylene-α-olefin copolymer (C) and the polypropylene resin composition containing the propylene polymer (A), the propylene-ethylene-α-olefin copolymer (B), the ethylene-α-olefin copolymer (C) and the inorganic filler (D) can be converted into resin compositions improved in fluidity by heating in the presence of an organic peroxide (D).

The organic peroxide (E) used in the present invention may be conventional organic peroxides, examples of which include an organic peroxide which has a decomposition temperature of lower than 120° C. at which the half life of the organic peroxide is one minute and an organic peroxide which has a decomposition temperature of 120° C. or higher at which the half life of the organic peroxide is one minute.

Examples of the organic peroxide which has a decomposition temperature of lower than 120° C. at which the half life of the organic peroxide is one minute include diacylperoxide compounds, percarbonate compounds (compounds (I) having a structure represented by the following formula (1) in the molecular skeleton) and alkyl perester compounds (compounds (II) having a structure represented by the following formula (2) in the molecular skeleton).

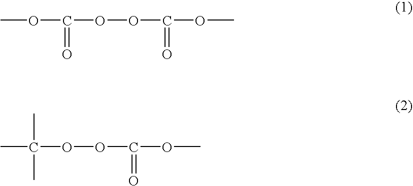

Examples of the compound (I) represented by the formula (1) include di-3-methoxybutyl peroxydicarbonate, di-2-ethylhexyl peroxydicarbonate, bis(4-tert-butylcyclohexyl) peroxydicarbonate, diisopropyl peroxydicarbonate, tert-butylperoxyisopropyl carbonate and dimyristyl peroxycarbonate.

Examples of the compounds (II) represented by the formula (2) include 1,1,3,3-tetramethylbutyl neodecanoate, α-cumylperoxy neodecanoate and tert-butylperoxy neodecanoate.

Examples of the organic peroxide which has a decomposition temperature of 120° C. or higher at which the half life of the organic peroxide is one minute include 1,1-bis(tert-butylperoxy)cyclohexane, 2,2-bis(4,4-di-tert-butylperoxycyclohexyl)propane, 1,1-bis(tert-butylperoxy)cyclododecane, tert-hexylperoxyisopropyl monocarbonate, tert-butylperoxy-3,5,5-trimethyl haxonoate, tert-butyl peroxylaurate, 2,5-dimethyl-2,5-di-(benzoylperoxy)hexane, tert-butyl peroxyacetate, 2,2-bis(tert-butylperoxy)butene, tert-butyl peroxybenzoate, n-butyl-4,4-bis(tert-butylperoxy)valerate, di-tert-butyl peroxyisophthalate, dicumyl peroxide, α,α′-bis(tert-butylperoxy-m-isopropyl)benzene, 2,5-dimethyl-2,5-di-(tert-butylperoxy)hexane, 1,3-bis(tert-butylperoxyisopropyl)benzene, tert-butyl cumyl peroxide, di-tert-butyl peroxide, p-menthane hydroperoxide and 2,5-dimethyl-2,5-di-(tert-butylperoxy)hexyne-3.

The added amount of the organic peroxide (E) is 0.005 to 10 parts by weight, preferably is 0.01 to 5 parts by weight, and more preferably is 0.01 to 1 part by weight relative to 100 parts by weight of the propylene polymer (A), the propylene-ethylene-α-olefin copolymer (B) and the ethylene-α-olefin copolymer (C) in total.

In the present invention, a resin composition composed of the propylene polymer (A), the propylene-ethylene-α-olefin copolymer (B) and the ethylene-α-olefin copolymer (C) is heat-treated in the presence of the organic peroxide (E), wherein the resin composition may further contain an inorganic filler. The heat treatment may be kneading under heating, which is described below.

### [Second Resin Composition]

The present invention also provides a second resin composition, which is a modification of the first resin composition.

The second resin composition has a composition in which the propylene-ethylene-α-olefin copolymer (B) in the first resin composition has been replaced by the following olefin-based polymer (B′).

Olefin-based polymer (B′): a polymer obtained by heating 100 parts by weight of a propylene-ethylene-α-olefin copolymer (b1) provided below or 100 parts of a mixture composed of not less than 25% by weight but less than 100% by weight of a propylene-ethylene-α-olefin copolymer (b1) and not more than 75% by weight of a propylene polymer (b4) selected from the group consisting of a propylene homopolymer (b2) and a propylene-ethylene copolymer (b3), in the presence of 0.001 to 20 parts by weight of an organic peroxide (E), wherein the olefin-based polymer (B′) has a melt index, measured at 230° C. under a load of 2.16 kg, of 10 to 100 g/10 minutes.

Propylene-ethylene-α-olefin copolymer (b1): a copolymer composed of 5 to 99 mol % of propylene units, 60 mol % or less of ethylene units and 1 to 35 mol % of α-olefin units, wherein the α-olefin has 4 to 20 carbon atoms, the copolymer has a molecular weight distribution of 1 to 4, an intrinsic viscosity of 0.5 to 10 dl/g and a heat of fusion of 30 J/g or less, wherein the content of the propylene units, the content of the ethylene units and the content of the α-olefin units, each in mol %, are based on the total amount of these monomer units.

In the preparation of the olefin-based polymer (B′), the propylene polymer (b4) is not indispensable; when this is incorporated, however, as to the mixing ratio of the propylene-ethylene-α-olefin copolymer (b1) and the propylene polymer (b4), the amount of (b4) is needed to be not more than 75% by weight relative to 100% by weight of both in total. If (b1) fails to exist in an amount of 25% by weight or more, the uniformity of foamed cells, which is an objective of the present invention, cannot be attained.

In the preparation of the olefin-based polymer (B′) can be used substances which are the same as the organic peroxide (E) to be used for the heat-treatment of the first resin composition.

The used amount of the organic peroxide (E) is 0.001 to 20 parts by weight and preferably 0.05 to 3 parts by weight relative to 100 parts by weight of the propylene-ethylene-α-olefin copolymer (b1) or 100 parts by weight of the mixture of the propylene-ethylene-α-olefin copolymer (b1) and the olefin-based polymer (b4).

The second resin composition may further contain an inorganic filler (D) in addition to the propylene polymer (A), the olefin-based polymer (B′) and the ethylene-α-olefin copolymer (C). The inorganic filler (D) which the second resin composition can contain is the same as the inorganic filler (D) which the first resin composition can contain.

The content of the inorganic filler (D) is 0.1 to 60 parts by weight relative to 100 parts by weight of the propylene polymer (A), the olefin-based copolymer (B′) and the ethylene-α-olefin copolymer (C) in total. From the viewpoint of impact resistance, it is preferably 1 to 30 parts by weight, and more preferably 5 to 20 parts by weight.

The molded article of the present invention is a molded article made of the polypropylene resin composition of the present invention. Examples of the method for molding the polypropylene resin composition of the present invention include injection molding, extrusion forming, rotation molding, vacuum molding, foam-molding and blow molding.

The foam-molded article of the present invention is a product obtained by adding a foaming agent to the polypropylene resin composition of the present invention, followed by molding. The foaming agent for use in the present invention may be a conventional foaming agent such as a chemical foaming agent and a physical foaming agent.

Specific examples of the method for foam-molding the polypropylene resin composition of the present invention include conventional methods such as an injection foam-molding, press foam-molding, extrusion foam molding and stampable foam-molding.

The foam-molded article of the present invention can be converted into a decorated foam-molded article by being combined with a skin material by insert molding, adhering or the like.

Conventional skin materials can be used as the aforesaid skin material. Specific examples of skin materials include woven fabric, non-woven fabric, knitted fabric, and film and sheet of thermoplastic resin or thermoplastic elastomer. Moreover, composite skin materials obtained by laminating sheets of polyurethane, rubber, thermoplastic elastomer or the like to skin materials such as those mentioned above may also be used.

Skin materials may further be provided with a cushion layer. Examples of the material which constitutes such a cushion layer include polyurethane foam, EVA foam, polypropylene foam and polyethylene foam.

Applications of the molded article of the present invention include interior or exterior components of automobiles, components of motorcycles, components of furniture or electric appliances.

Examples of the automotive interior components include instrument panels, trims, door panels, side protectors, console boxes, and column covers. Examples of the automotive exterior components include bumpers, fenders, and wheel covers.

Examples of the motorcycle components include cowlings, and muffler covers.

### EXAMPLES

The present invention is further described below with reference to Examples and Comparative Examples, but the present invention is not limited to them.

In the Examples or Comparative Examples, the resins and additives shown below were used.

### (1) Propylene-Ethylene Block Copolymer (A-1)

This was produced by solvent polymerization using the solid catalyst component disclosed in JP 7-216017 A.

MI (230° C., 2.16 kg-load): 130 g/10 min

Intrinsic viscosity of the entire propylene-ethylene block copolymer, [η]T: 1.4 dl/g

Intrinsic viscosity of the propylene homopolymer portion, [η]P: 0.8 dl/g

Weight ratio of the propylene-ethylene random copolymer component to the entire copolymer: 12% by weight Intrinsic viscosity of the propylene-ethylene random copolymer component, [η]EP: 6.0 dl/g

Ethylene unit content of the propylene-ethylene random copolymer component: 30% by weight

### (2) Propylene Homopolymer (A-2)

This was produced by vapor phase polymerization using the solid catalyst component disclosed in JP 7-216017 A.

MI (230° C., 2.16 kg-load): 20 g/10 min

### (3) Propylene Homopolymer (A-3)

Commercial name: U501E1 (produced by Sumitomo Chemical Co., Ltd.)

MI (230° C., 2.16 kg-load): 120 g/10 min

### (4) Propylene Homopolymer (A-4)

This was produced by vapor phase polymerization using the solid catalyst component disclosed in JP-A 7-216017.

MI (230° C., 2.16 kg-load): 300 g/10 min

### (5) Propylene Homopolymer (A-5)

Commercial name: FS2011DG3 (produced by Sumitomo Chemical Co., Ltd.)

MI (230° C., 2.16 kg-load): 2.5 g/10 min

### (6) Propylene-Ethylene Block Copolymer (A-6)

This was produced by solvent polymerization using the solid catalyst component disclosed in JP 7-216017 A.

MI (230° C., 2.16 kg-load): 30 g/10 min

Intrinsic viscosity of the entire propylene-ethylene block copolymer, [η]T: 1.4 dl/g

Intrinsic viscosity of the propylene homopolymer portion, [η]P: 1.06 dl/g

Weight ratio of the propylene-ethylene random copolymer component to the entire copolymer: 20.5% by weight

Intrinsic viscosity of the propylene-ethylene random copolymer component, [η]EP: 2.8 dl/g

Ethylene unit content of the propylene-ethylene random copolymer component: 37% by weight

### (7) Propylene-Ethylene Block Copolymer (A-7)

This was produced by solvent polymerization using the solid catalyst component disclosed in JP 7-216017 A.

MI (230° C., 2.16 kg-load): 30 g/10 min

Intrinsic viscosity of the entire propylene-ethylene block copolymer, [I]T: 1.5 dl/g

Intrinsic viscosity of the propylene homopolymer portion, [η]P: 1.05 dl/g

Weight ratio of the propylene-ethylene random copolymer component to the entire copolymer: 16% by weight

Intrinsic viscosity of the propylene-ethylene random copolymer component, [η]EP: 4.0 dl/g

Ethylene content of the propylene-ethylene random copolymer component: 45% by weight

(8) Propylene-1-butene Copolymer (B-1)

From the bottom of a 100 L, SUS polymerization reactor having outside a jacket for circulating cooling water and equipped with a stirrer were fed continuously hexane as a polymerization solvent at a rate of 100 L/h, propylene at a rate of 24.00 kg/h, 1-butene at a rate of 1.81 kg/h, dimethylsilyl(tetramethylcyclopentadieny) (3-tert-butyl-5-methyl-2-phenoxy)titanium dichloride disclosed in Example 25 of JP 9-87313 A at a rate of 0.005 g/h, triphenylmethyltetrakis(pentafluorophenyl) borate at a rate of 0.298 g/h, triisobutylaluminum at a rate of 2.315 g/h, and hydrogen as a molecular weight regulator, followed by continuous copolymerization at 45° C.

To a reaction mixture extracted continuously from the top of the reactors so that the amount contained in the reactor might be kept at 100 L, a small amount of ethanol was added to stop the polymerization reaction. Then, removal of monomers and washing with water were carried out, and subsequently the solvent was removed with steam in a large amount of water, so that a propylene-1-butene copolymer (B-1) was obtained. This was dried at 80° C. under reduced pressure overnight. The rate of generation of the copolymer was 7.10 kg/h. The structural characteristics of the resulting copolymer (B-1) are shown in Table 1.

TABLE 1

| | Structure of copolymer | | | | | | |
|---|---|---|---|---|---|---|---|
| | Ethylene | | Butene | | Molecular | Intrinsic | Heat of |
| | (x) | Propylene | (y) | | weight | viscosity | fusion |
| | mol % | mol % | mol % | y/(x + y) | distribution | dl/g | J/g |
| B-1 | 0 | 96 | 4 | 1.00 | 2.1 | 2.5 | 0 |

(9) Propylene-1-butene Copolymer Masterbatch
(9-1) Propylene-1-butene Copolymer Masterbatch (B)

A propylene-1-butene copolymer masterbatch which was composed of 70% by weight of the propylene-1-butene copolymers (B-1) obtained above and 30% by weight of the propylene homopolymer (A-5). The MI, measured at 230° C. under a load of 2.16 kg, was 2.6 g/10 minutes.

(9-2) Propylene-1-butene Copolymer Masterbatch (B′)

To 100 parts by weight of the above-obtained propylene-1-butene copolymer masterbatch (B) was added 0.12 parts by weight of an organic peroxide (commercial name: Perkadox 14R-P, produced by Kayaku Akzo Corp.). The mixture was premixed uniformly and then was kneaded and extruded using a 40-mmφ full-flight, single screw kneading machine (manufactured by Tanabe Plastics Machinery Co., Ltd., L/D=28) at 250° C., at a screw rotation speed of 100 rpm, giving masterbatch pellets (B′). The MI, measured at 230° C. under a load of 2.16 kg, was 27.5 g/10 minutes.

(10) Ethylene-α-olefin Copolymer (C)

### (C-1) Ethylene-butene Copolymer Rubber

Commercial name: CX5505 (produced by Sumitomo Chemical Co., Ltd.)

Density: 0.875 g/cm³

MI (190° C., 2.16 kg-load): 14 g/10 min

### (C-2) Ethylene-butene Copolymer Rubber

Commercial name: GA801 (produced by Sumitomo Chemical Co., Ltd.)

Density: 0.920 g/cm³

MI (190°, 2.16 kg-load): 20 g/10 min

### (C-3) Ethylene-butene Copolymer Rubber

Commercial name: CX5501 (produced by Sumitomo Chemical Co., Ltd.)

Density: 0.880 g/cm³

MI (190° C., 2.16 kg-load): 30 g/10 min

### (C-4) Ethylene-butene Copolymer Rubber

Commercial name: A35050 (produced by Mitsui Chemicals, Inc.)

Density: 0.863 g/cm³

MI (190° C., 2.16 kg-load): 35 g/10 min

### (C-5) Ethylene-Butene Copolymer Rubber

Commercial name: A6050 (produced by Mitsui Chemicals, Inc.)

Density: 0.863 g/cm³

MI (190° C., 2.16 kg-load): 6 g/10 min

### (C-6) Ethylene-octene Copolymer Rubber

Commercial name: ENGAGE 8407 (produced by The Dow Chemical Co.)

Density: 0.870 g/cm³

MI (190° C., 2.16 kg-load): 34 g/10 min

### (11) Talc (D)

Commercial name: JR-46 (particle diameter=2.7 μm) produced by Hayashi Chemical Co., Ltd.

### (12) Talc Masterbatch (D′)

Commercial name: MF110 (produced by Sumitomo Chemical Co., Ltd.) (a masterbatch which contains propylene-ethylene block copolymer (A-7) and talc (D), the talc content being 70% by weight)

### (13) Organic Peroxide (E)

Commercial name: Perkadox 14R-P, produced by Kayaku Akzo Corp.

### Example 1

### Comparative Examples 1 and 2

Inorganic filler-containing polypropylene resin compositions were produced in accordance with the following method.

The ingredients in the weight proportions given in Table 2 were premixed with a tumbler uniformly. Then, the mixture was kneaded and extruded using a twin screw kneading extruder (TEX44SS 30BW-2V, manufactured by The Japan Steel Works, Ltd.) at a cylinder temperature of 200° C., an extrusion rate of 30 to 50 kg/hr, a screw rotation speed of 300 rpm, under vent suction to produce an inorganic filler-containing polypropylene polymer composition.

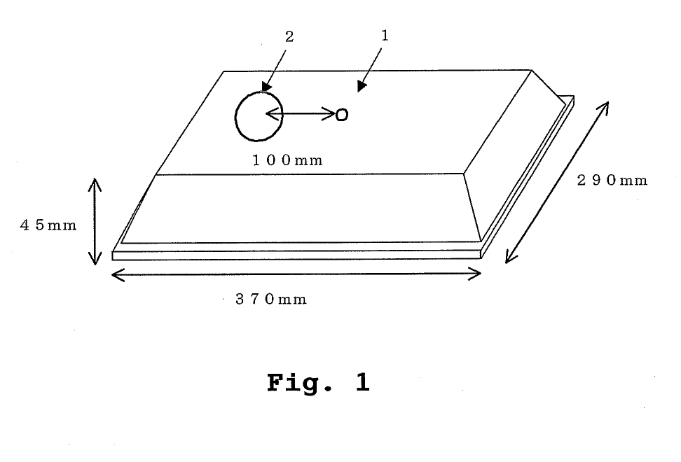

Using the inorganic filler-containing polypropylene resin composition, injection foam-molding was conducted by the use of an injection molding machine ES2550/400HL-MuCell (clamping force=400 tons) manufactured by ENGEL. Carbon dioxide as a foaming agent was injected in a supercritical state into the cylinder portion, followed by molding. A mold was used with which a box-shaped molded article having approximate dimensions depicted in FIG. 1 would be obtained. The dimensions of the molded articles were 290 mm×370 mm and a height of 45 mm. The used mold had a basic cavity clearance (i.e., initial wall thickness) defined in a closed state of 1.5 mm and had a gate structure which was a direct gate.

The cylinder temperature and the mold temperature were preset to 250° C. and 50° C., respectively. After closing the mold, injection of the composition containing a foaming agent was started. After completely filling up the mold cavity with the composition by injection thereof, a cavity surface of the mold was retracted by 2.0 mm to enlarge the cavity, thereby foaming the composition. The foamed composition was further cooled to solidify completely, so that a foam molded article was obtained. Examination was performed with respect to the condition of the generation of silver streaks within a 60 mm diameter round area illustrated in FIG. 1 with center at a position 100 mm away from the gate portion of the foam-molded article. The results are shown in Table 2.

The methods for measuring physical properties of the resin components and the compositions used in the Examples and the Comparative Examples are described below.

(1) Melt Index (MI, Unit: g/10 min)

The melt index was measured by the method provided in JIS K6758.

### (2) Structural Analysis of Propylene-Ethylene Block Copolymer

### (2-1) Intrinsic Viscosity of Propylene-Ethylene Block Copolymer

### (2-1-a) Intrinsic Viscosity of Propylene Homopolymer Portion: [η]P

The intrinsic viscosity of a propylene homopolymer portion of a propylene-ethylene block copolymer, [η]P, was measured by extracting a propylene homopolymer from the polymerization reactor after the production of the propylene homopolymer during the production of the block copolymer, and then measuring the [η]P of the propylene homopolymer extracted.

### (2-1-b) Intrinsic Viscosity of Propylene-Ethylene Random Copolymer Portion: [η]EP

The intrinsic viscosity [η]P of the propylene homopolymer portion of a propylene-ethylene block copolymer and the intrinsic viscosity [η]T of the entire portion of the propylene-ethylene block copolymer were measured respectively, and then the intrinsic viscosity [η]EP of the propylene-ethylene random copolymer portion of the propylene-ethylene block copolymer was calculated from the following formula using the weight ratio X of the propylene-ethylene random copolymer portion to the entire portion of the propylene-ethylene block copolymer.

[η]EP=[η]T/X−(1/X−1)[η]P

[η]EP: Intrinsic viscosity (dl/g) of the propylene homopolymer portion

[η]T: Intrinsic viscosity (dl/g) of the entire portion of the propylene-ethylene block copolymer

### (2-1-c) Weight Ratio X of Propylene-Ethylene Random Copolymer Portion to the Entire Portion of Propylene-Ethylene Block Copolymer

The weight ratio X to the propylene-ethylene random copolymer portion to the entire portion of a propylene-ethylene-block copolymer was determined by measuring the heat of fusion of the propylene homopolymer portion and that of the entire portion of the propylene-ethylene block copolymer, respectively, followed by calculation using the following formula. The heat of fusion was measured by differential scanning calorimetry (DSC).

X=1−(ΔHf)T/(ΔHf)P

(ΔHf)T: Heat of fusion of the block copolymer (cal/g)

(ΔHf)P: Heat of fusion of the propylene homopolymer (cal/g)

### (3) Ethylene Content (C2′)EP of Propylene-Ethylene Random Copolymer Portion in Propylene-Ethylene Block Copolymer

The ethylene content (C2′)EP of the propylene-ethylene random copolymer portion of a propylene-ethylene block copolymer was determined by measuring the ethylene content (C2′)T of the entire portion of the propylene-ethylene block copolymer by the infrared absorption spectrum method, followed by a calculation using the following formula.

(C2′)EP=(C2′)T/X

(C2′)T: Ethylene content of the entire portion of the propylene-ethylene random copolymer (% by weight)

(C2′)EP: Ethylene content of the propylene-ethylene random copolymer portion (% by weight)

X: Weight ratio of the propylene-ethylene random copolymer portion to the entire portion of the propylene-ethylene block copolymer

### (4) The Amount of the Heat of Fusion of Copolymer (B-1)

The measurement was performed under the following conditions using a differential scanning calorimeter (DSC RDC220 manufactured by Seiko Instruments & Electronics Ltd.).

(i) A sample (about 5 mg) was increased in temperature from room temperature to 200° C. at a rate of 30° C./min and after the completion of the temperature increase, it was held for 5 minutes.

(ii) Subsequently, the temperature was decreased from 200° C. to −100° C. at a rate of 10° C./min.

(iii) After the completion of the temperature decrease, the sample was held for 5 minutes and then was heated from −100° C. to 200° C. at a rate of 10° C./min.

(iv) The peak observed in (iv) was a fusion peak and the amount of heat of fusion was calculated from the area of the peak.

### (5) Molecular Weight Distribution of Copolymer (B-1)

The measurement was conducted under the following conditions by gel permeation chromatography (GPC). From the results obtained, a weight average molecular weight (Mw) and a number average molecular weight (Mn) were calculated, and then a molecular weight distribution (Mw/Mn) was calculated.

Instrument: 150 C ALC/GPC manufactured by Waters

Column: Shodex Packed Column A-80M (two columns) manufactured by Showa Denko K.K.

Temperature: 140° C.

Solvent: o-Dichlorobenzene

Eluant flow rate: 1.0 ml/min

Sample concentration: 1 mg/ml

Injection amount: 400 μL.

Molecular weight standard substance: Standard polystyrenes

Detector: Differential refractometer

### (6) Fluidity

A resin composition was molded at a resin temperature of 260° C. by the use of a mold for the measurement of a resin flow length having a spiral flow passage of 2 mm in thickness, 10 mm in width and 2000 mm in length. The flow length (mm) of the resulting molded article was measured, and the length was used as the flow length.

### (7) Appearance Evaluation of Foam-Molded Article (Silver Streaks)

A region surrounded by a circle of 60 mm in diameter shown in FIG. 1 of a polypropylene resin composition foam-molded article produced by foam-molding, the region being 100 mm away from the gate portion of the molded article, was visually evaluated and judgment was made according to the following criteria.

◯: No silver streak in the surface of the foam-molded article is recognized visually.

Δ: Silver streaks are slightly noticeable.

x: Silver streaks are clearly noticeable.

### (8) Appearance Evaluation of a Foam-Molded Article (Corrugation)

The region within 100 mm from the gate portion of a polypropylene resin composition foam molded article obtained by foam molding was evaluated visually, and was judged as follows.

◯: Corrugation of the surface of a foam-molded article is hardly recognizable.

Δ: Corrugation is recognizable a little.

x: Corrugation is apparently recognizable.

### (9) Evaluation of Foamed Cell Condition of Foam-Molded Article

A cross section of a site 20 mm away from the gate portion of a polypropylene resin composition foam-molded article obtained by foam-molding and a cross section of a site 100 mm away from the gate portion were evaluated visually, and were judged as follows.

◯: The site 20 mm away from the top surface gate and the site 100 mm away from the top surface gate are almost the same in foamed cell structure and the foam condition of the foam molded article is uniform.

x: Breakage, rupture or the like was found in foamed cells present in a site 100 mm away from the top surface gate and the foam condition of the foam molded article is not uniform.

TABLE 2

Composition

| | |
|---|---|
| | part by |
| % by weight | weight |

| | | | | | | | | |
|---|---|---|---|---|---|---|---|---|
| Example 1 | A-1 | | | A-4 | B | C-1 | | |
| | 40.0 | | | 29.7 | 14.3 | 16.0 | | |
| Example 2 | A-1 | | | A-4 | B | C-1 | D′ | |
| | 39.4 | | | 29.3 | 15.7 | 14.1 | 5.0 | |
| Example 3 | A-1 | A-2 | A-3 | | B | C-1 | D′ | |
| | 39.4 | 3.6 | 25.7 | | 14.1 | 15.7 | 5.0 | |
| Example 4 | A-1 | | | A-4 | B | C-3 | D′ | |
| | 39.4 | | | 29.3 | 14.1 | 15.7 | 5.0 | |
| Example 5 | A-1 | | | A-4 | B | C-4 | D′ | |
| | 39.4 | | | 29.3 | 14.1 | 15.7 | 5.0 | |
| Example 6 | A-1 | | | A-4 | B | C-6 | D′ | |
| | 39.4 | | | 29.3 | 14.1 | 15.7 | 5.0 | |
| Example 7 | A-1 | | | A-4 | B | C-1 | | E |
| | 40.0 | | | 29.7 | 14.3 | 16.0 | | 0.008 |
| Example 8 | A-1 | | | A-4 | B | C-1 | | E |
| | 40.0 | | | 29.7 | 14.3 | 16.0 | | 0.024 |
| Example 9 | A-1 | A-2 | | A-4 | B | C-1 | D′ | E |
| | 39.4 | 5.9 | | 29.3 | 14.1 | 9.8 | 5.0 | 0.024 |
| Example 10 | A-1 | | | A-4 | B | C-1 | D′ | E |
| | 39.4 | | | 29.3 | 14.1 | 15.7 | 5.0 | 0.024 |
| Example 11 | A-1 | | | A-4 | B | C-1 | D′ | E |
| | 39.4 | | | 20.4 | 14.1 | 24.6 | 5.0 | 0.024 |
| Example 12 | | | A-6 | A-4 | B | C-1 | D′ | E |
| | | | 39.4 | 29.3 | 14.1 | 15.7 | 5.0 | 0.024 |
| Comparative | A-1 | | | | | C-1 | | E |
| Example 1 | 77.0 | | | | | 23.0 | | 0.072 |
| Comparative | | | A-5 | | | C-1 | | E |
| Example 2 | | | 97.0 | | | 3.0 | | 0.4 |
| Comparative | A-1 | A-2 | A-3 | | | C-1 | D′ | |
| Example 3 | 39.4 | 6.9 | 26.6 | | | 25.6 | 5.0 | |
| Comparative | A-1 | | | A-4 | B | C-2 | D′ | |
| Example 4 | 39.4 | | | 29.3 | 15.7 | 14.1 | 5.0 | |
| Comparative | A-1 | | | A-4 | B | C-5 | D′ | |
| Example 5 | 39.4 | | | 29.3 | 14.1 | 15.7 | 5.0 | |
| Comparative | A-1 | | | A-4 | B | C-2 | D′ | E |
| Example 6 | 39.4 | | | 29.3 | 14.1 | 15.7 | 5.0 | 0.024 |

| | Content of B | Content of D | | | | | |
|---|---|---|---|---|---|---|---|
| | in | in | | | Appearance | | |
| | composition | composition | | Flow | evaluation | | |
| | (% by | (% by | MI | length | Silver | | Foam |
| | weight) | weight) | g/10 min | mm | streak | Corrugation | condition |
| Example 1 | 10 | 0 | 43 | 614 | ◯ | Δ | ◯ |
| Example 2 | 11 | 3.5 | 45 | — | ◯ | Δ | ◯ |
| Example 3 | 11 | 3.5 | 56 | — | ◯ | Δ | ◯ |
| Example 4 | 11 | 3.5 | 50 | 646 | Δ | X | X |
| Example 5 | 11 | 3.5 | 48 | 629 | ◯ | X | ◯ |
| Example 6 | 11 | 3.5 | 47 | 631 | Δ | X | ◯ |
| Example 7 | 10 | 0 | 53 | 664 | ◯ | ◯ | ◯ |
| Example 8 | 10 | 0 | 73 | 715 | ◯ | ◯ | ◯ |
| Example 9 | 11 | 3.5 | 68 | 690 | Δ | ◯ | X |
| Example 10 | 11 | 3.5 | 70 | 695 | ◯ | ◯ | X |
| Example 11 | 11 | 3.5 | 49 | 595 | ◯ | ◯ | X |
| Example 12 | 11 | 3.5 | 43 | 562 | ◯ | ◯ | ◯ |
| Comparative | 0 | 0 | 80 | 740 | X | X | X |
| Example 1 | | | | | | | |
| Comparative | 0 | 0 | 80 | 680 | X | Δ | X |
| Example 2 | | | | | | | |
| Comparative | 0 | 3.5 | 58 | — | X | X | ◯ |
| Example 3 | | | | | | | |
| Comparative | 11 | 3.5 | 48 | — | X | X | X |
| Example 4 | | | | | | | |
| Comparative | 11 | 3.5 | 46 | 611 | X | X | ◯ |
| Example 5 | | | | | | | |
| Comparative | 11 | 3.5 | 74 | 701 | X | ◯ | X |
| Example 6 | | | | | | | |

In Table 2, the sum total of the amounts of the polypropylenes in component A, component B (or component B′), component C and component D′ is 100% by weight.

### INDUSTRIAL APPLICABILITY

Particularly, in foam-molding of the polyolefin resin composition of the present invention, generation of silver streaks is inhibited effectively and it is possible to obtain a molded article with good appearance. It is also possible to obtain a molded article having few silver streaks and little corrugation or a molded article which has few silver streaks and uniform foamed cells.

1. A polypropylene resin composition comprising:
50 to 90% by weight of a propylene polymer (A) selected from the group consisting of a propylene homopolymer (A-1) and a propylene-ethylene copolymer (A-2),
5 to 20% by weight of the following propylene-ethylene-α-olefin copolymer (B), and
5 to 30% by weight of the following ethylene-α-olefin copolymer (C), and
having a melt index, measured at 230° C. under a load of 2.16 kg, of greater than 40 g/10 minutes but not greater than 200 g/10 minutes, wherein the amounts of the propylene polymer (A), the propylene-ethylene-α-olefin copolymer (B) and the ethylene-α-olefin copolymer (C) are each relative to the total amount of these components,
propylene-ethylene-α-olefin copolymer (B): a copolymer composed of 5 to 99 mol % of propylene units, 60 mol % or less of ethylene units and 1 to 35 mol % of α-olefin units, wherein the α-olefin has 4 to 20 carbon atoms, the copolymer has a molecular weight distribution of 1 to 4, an intrinsic viscosity of 0.5 to 10 dl/g and a heat of fusion of 30 J/g or less, wherein the content of the propylene units, the content of the ethylene units and the content of the α-olefin units, each in mol %, are based on the total amount of these monomer units,
ethylene-α-olefin copolymer (C): a copolymer of ethylene and α-olefin having a density of 0.85 to 0.89 g/cm³, wherein the α-olefin has 4 to 20 carbon atoms.

2. The polypropylene resin composition according to claim 1 further comprising 0.1 to 60 parts by weight, relative to 100 parts by weight of the propylene polymer (A), propylene-ethylene-α-olefin copolymer (B) and the ethylene-α-olefin copolymer (C) in total, of an inorganic filler (D).

3. A polypropylene resin composition obtained by heat treating the polypropylene resin composition of claim 1 in the presence of 0.005 to 10 parts by weight, relative to 100 parts by weight of the propylene polymer (A), the propylene-ethylene-α-olefin copolymer (B) and the ethylene-α-olefin copolymer (C) in total, of an organic peroxide (E).

4. A polypropylene resin composition obtained by heat treating the polypropylene resin composition of claim 2 in the presence of 0.005 to 10 parts by weight, relative to 100 parts by weight of the propylene polymer (A), the propylene-ethylene-α-olefin copolymer (B) and the ethylene-α-olefin copolymer (C) in total, of the organic peroxide (E).

5. A polypropylene resin composition for foam-molding comprising:
50 to 90% by weight of a propylene polymer (A) selected from the group consisting of a propylene homopolymer (A-1) and a propylene-ethylene copolymer (A-2),
5 to 20% by weight of the following olefin-based polymer (B′), and
5 to 30% by weight of the following ethylene-α-olefin copolymer (C), and
having a melt index, measured at 230° C. under a load of 2.16 kg, of greater than 40 g/10 minutes but not greater than 200 g/10 minutes, wherein the foregoing amounts of the propylene polymer (A), the olefin-based polymer (B′) and the ethylene-α-olefin copolymer (C) are each relative to the total amount of these components,
olefin-based polymer (B′): a polymer obtained by heating 100 parts by weight of a propylene-ethylene-α-olefin copolymer (b 1) provided below or 100 parts of a mixture composed of not less than 25% by weight but less than 100% by weight of a propylene-ethylene-α-olefin copolymer (b1) and not more than 75% by weight of a propylene polymer (b4) selected from the group consisting of a propylene homopolymer (b2) and a propylene-ethylene copolymer (b3), in the presence of 0.001 to 20 parts by weight of the organic peroxide (E), wherein the olefin-based polymer (B′) has a melt index, measured at 230° C. under a load of 2.16 kg, of 10 to 100 g/10 minutes,
propylene-ethylene-α-olefin copolymer (b1): a copolymer composed of 5 to 99 mol % of propylene units, 60 mol % or less of ethylene units and 1 to 35 mol % of α-olefin units, wherein the α-olefin has 4 to 20 carbon atoms, the copolymer has a molecular weight distribution of 1 to 4, an intrinsic viscosity of 0.5 to 10 dl/g and a heat of fusion of 30 J/g or less, wherein the content of the propylene units, the content of the ethylene units and the content of the α-olefin units, each in mol %, are based on the total amount of these monomer units,
ethylene-α-olefin copolymer (C): a copolymer of ethylene and α-olefin having a density of 0.85 to 0.89 g/cm³, wherein the α-olefin has 4 to 20 carbon atoms.

6. The polypropylene resin composition according to claim 5 further comprising 0.1 to 60 parts by weight, relative to 100 parts by weight of the propylene polymer (A), the olefin-based copolymer (B′) and the ethylene-α-olefin copolymer (C) in total, of an inorganic filler (D).

7. An injection molded article comprising the polypropylene resin composition according to claim 1.

8. A foam-molded article comprising the polypropylene resin composition according to claim 1.
